(19) United States
(12) Patent Application Publication
(10) Pub. No.: US 2017/0372672 A1
(43) Pub. Date: Dec. 28, 2017

(54) LIQUID CRYSTAL DISPLAY DEVICE, AND METHOD OF MANUFACTURING LIQUID CRYSTAL DISPLAY DEVICE

(71) Applicant: Sharp Kabushiki Kaisha, Sakai City, Osaka (JP)

(72) Inventor: MAKOTO SHIOMI, Sakai City (JP)

(21) Appl. No.: 15/544,708

(22) PCT Filed: Jan. 8, 2016
(86) PCT No.: PCT/JP2016/050474

§ 371 Date: Jul. 19, 2017

(30) Foreign Application Priority Data
Jan. 20, 2015 (JP) 2015-008940

(51) Int. Cl. G09G 3/36; G02F 1/1345; G09G 3/00; G02F 1/1362; G02F 1/1368

(52) U.S. Cl. CPC G09G 3/3688; G02F 1/136259; G02F 1/136286; G02F 1/1368; G09G 3/006; G02F 1/13452; G09G 2310/08; G09G 2330/08; G09G 2340/14; G02F 2001/136263

(57) ABSTRACT

The liquid crystal display device includes: a control circuit (5) configured to perform input correction for a plurality of pixels (i1 to i12, j1 to j12, and k1 to k12) in each one of blocks (Bi1, Bj1, and Bk1) of a display unit (2), the input correction performed separately for each local area; a first source driver (4a) electrically connected to an end of each one of data signal lines (S1 to S24) that correspond to the pixels; and a second source driver (4b) electrically connected to another end of each data signal line (S1 to S24), wherein the first and second source drivers (4a and 4b) drive the data signal lines (S1 to S24) based on the input correction.

### TECHNICAL FIELD

The present invention relates to liquid crystal display devices and methods of manufacturing liquid crystal display devices.

### BACKGROUND ART

Liquid crystal display devices with 2K1K resolution (approximately 2000 picture elements in the lateral direction×1000 picture elements in the longitudinal direction) exhibit a pixel charging rate with a sufficient margin. If a data signal line is broken, the device can be repaired by using redundant wiring that is provided in advance around the display unit. The data signal can be delivered to the broken data signal line via the redundant wiring without causing appreciable display unevenness. The margin of the pixel charging rate is, however, decreasing with progressive increase in physical size of the display unit. There is a configuration (see (a) of FIG. 10) implemented to address this problem, in which each data signal line SL is divided into an upper portion SLa and a lower portion SLb that are driven by separate source drivers SDa and SDb respectively, in order to guarantee a sufficient charging rate for the pixel PIX (connected to the data signal line SLa and a scan signal line GL via transistors).

Meanwhile, the liquid crystal display device has some area of continuously changing unevenness due to structural elements such as the backlight, optical films, and liquid crystal panel. This “inherent unevenness” can be alleviated by dividing the display unit into a plurality of local areas and correcting pixel data in each local area.

### CITATION LIST

### Patent Literature

Patent Literature 1: PCT International Application Publication, No. WO2012/157093 (Publication Date: Nov. 22, 2012)

### SUMMARY OF INVENTION

### Technical Problem

The configuration shown in (a) of FIG. 10 completely fails to provide a solution to the broken data signal line shown in (b) of FIG. 10. This is a serious issue in high-end, high-resolution (e.g., 8K4K) liquid crystal display devices.

One of objects of the present invention is to provide a liquid crystal display device that reliably exhibits a sufficient pixel charging rate with a large display unit and that affords a solution to broken data signal line problems without compromising on display quality.

### Solution to Problem

The present invention is directed to a liquid crystal display device including: a control circuit configured to perform input correction for a plurality of pixels in each one of local areas of a display unit, the input correction performed separately for each local area; a first driver electrically connected to an end of each one of data signal lines that correspond to the pixels; and a second driver electrically connected to another end of each data signal line, wherein the first and second drivers drive the data signal lines based on the input correction.

### Advantageous Effects of Invention

In the liquid crystal display device in accordance with the present invention, the first and second drivers drive each data signal line. Therefore, the liquid crystal display device exhibits a sufficient pixel charging rate with a large display unit and if one of the data signal lines is, for example, broken, still allows for individual driving of the two parts separated by the broken site. In addition, if at least one of the data signal lines corresponding to the pixels in a local area is broken, all the other data signal lines are deliberately disconnected, and input correction is performed considering this new condition. This configuration suppresses unevenness that occurs due to broken and disconnected data signal lines, enabling correction of the broken data signal line without compromising on display quality.

### BRIEF DESCRIPTION OF DRAWINGS

FIG. 1 is a schematic view of a configuration of a liquid crystal display device in accordance with Embodiment 1.

FIG. 2 is a functional diagram depicting a function (only inherent unevenness correction) of a control circuit in the liquid crystal display device.

In FIG. 3, portion (a) is an example of a display produced on the liquid crystal display device if the liquid crystal display device has no broken data signal line and is subjected to no unevenness correction, and portion (b) is an example of a display produced if the liquid crystal display device has no broken data signal line and is subjected to inherent unevenness correction.

In FIG. 4, portion (a) is a configuration example when the liquid crystal display device has a broken data signal line, and portion (b) is an example of a display produced on the liquid crystal display device if the liquid crystal display device has a broken data signal line and is subjected only to inherent unevenness correction.

FIG. 5 is a schematic view of a configuration of the liquid crystal display device in which a broken data signal line is corrected.

In FIG. 6, portion (a) is an example of a display produced on the liquid crystal display device if the liquid crystal display device, having undergone broken data signal line correction, is subjected only to inherent unevenness correction, and portion (b) is an example of a display produced if the liquid crystal display device, having undergone broken data signal line correction, is subjected to inherent unevenness correction and broken-line-/disconnected-line-caused unevenness correction.

FIG. 7 is a functional diagram depicting functions (both inherent unevenness correction and broken-line-/disconnected-line-caused unevenness correction) of the control circuit in the liquid crystal display device.

FIG. 8 is a schematic view of a configuration of the liquid crystal display device in which a short-circuited data signal line is corrected.

FIG. 9 is a schematic view of another configuration of the liquid crystal display device in accordance with Embodiment 1.

In FIG. 10, portions (a) and (b) are schematic views of a configuration of a conventional liquid crystal display device.

### DESCRIPTION OF EMBODIMENTS

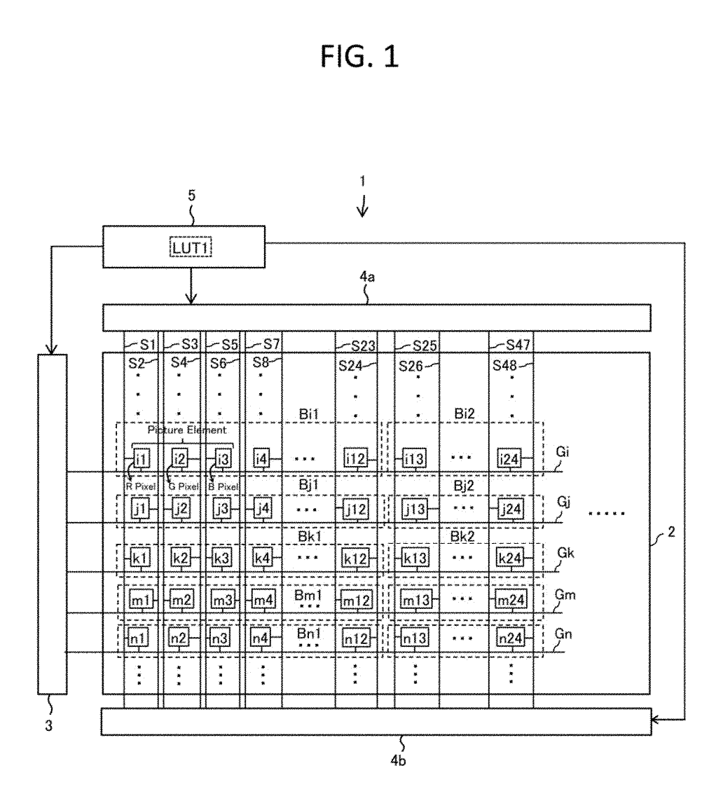

The following will describe embodiments of the present invention in reference to FIGS. 1 to 9. FIG. 1 is a schematic view of a configuration of a liquid crystal display device in accordance with the present invention. As shown in FIG. 1, a liquid crystal display device 1 includes a display unit 2, a source driver 4a (first driver), a source driver 4b (second driver), a gate driver 3, and a control circuit 5. The display unit 2 includes scan signal lines Gi, Gj, Gk, Gm, and Gn, data signal lines S1 to S48, and pixels i1 to i24, j1 to j24, k1 to k24, m1 to m24, and n1 to n24. The source driver 4a is disposed in an upper portion of the display unit 2 and connected to an end of each data signal line S1 to S48. The source driver 4b is disposed in a lower portion of the display unit 2 and connected to the other end of each data signal line S1 to S48. The gate driver 3 drives the scan signal lines Gi to Gk. The control circuit 5 controls the gate driver 3 and the source drivers 4a and 4b. The display unit 2 further includes a liquid crystal panel in which each pixel is connected to an associated data signal line and an associated scan signal line via transistors. The liquid crystal display device 1 further includes, for example, a backlight (not shown) and optical films.

In the liquid crystal display device 1, each data signal line is driven by the two source drivers 4a and 4b (“double-sided source input drive”), Throughout the following description, the direction in which the scan signal lines extend will be referred to as the “row direction” or the “lateral direction;” the direction in which the data signal lines extend will be referred to as the “column direction” or the “longitudinal direction.”

In the display unit 2, each picture element includes a red (R) pixel (e.g., a pixel i1), a green (G) pixel (e.g., a pixel i2), and a blue (B) pixel (e.g., a pixel i3). The display unit 2 includes, for example, 8K4K picture elements (7680 picture elements in the lateral direction×4320 picture elements in the longitudinal direction). Considering current LCD manufacturing and driving technology, if the refresh rate is 60 Hz, the display unit 2 very preferably includes at least 3240 picture elements in the longitudinal direction (3240 scan signal lines) and diagonally measures at least 60 inches. Examples of such a display unit include integral multiples of 2K1K, which is a current base model (i.e., 1920×1080, 2048×1080, 1920×1200, and 2048×1200 from the television standards, digital cinema standards, PC monitor standards, and the like), such as 4K4K, 6K3K, 6K4K, and 8K4K. If the picture element count or diagonal dimension is smaller than these examples, charging has a sufficient margin to allow for single-sided source input drive in which the source driver is provided on a single side and to thereby enable suitable application of auxiliary wiring correction and other related technology. Note however that because the charging rate loses margin at high refresh rates, if the refresh rate is, for example, 120 Hz, the present invention is also suitably applicable to display units with approximately 4K2K picture elements.

The display unit 2 has a “double source structure” and includes two data signal lines for each column of pixels. Specifically, the odd-numbered pixels in a column of pixels are connected to one of the two data signal lines via transistors, and the even-numbered ones are connected to the other data signal line via transistors.

For example, as to the column-wise adjoining pixels i1, j1, and k1, the pixel i1 is connected to the data signal line S1 via a transistor, the pixel j1 is connected to the data signal line S2 via a transistor, and the pixel k1 is connected to the data signal line S1 via a transistor.

As to the column-wise adjoining pixels i2, j2, and k2, the pixel i2, adjoining the pixel i1 in the row direction, is connected to the data signal line S4 via a transistor, the pixel j2, adjoining the pixel j1 in the row direction, is connected to the data signal line S3 via a transistor, and the pixel k2, adjoining the pixel k1 in the row direction, is connected to the data signal line S4 via a transistor. The data signal lines S2 and S3 are located next to each other in this example. In a double source structure, two-line simultaneous selection is performed in which two adjacent scan signal lines are selected at a time. For example, the scan signal lines Gi and Gj are simultaneously selected before the scan signal lines Gk and Gm are simultaneously selected. Note that because each picture element in the display unit 2 shown in FIG. 1 includes 3 pixels (R, G, and B), there are provided 6 data signal lines for each column of picture elements; if, for example, each picture element includes 4 pixels (R, G, B, and Y), there are provided 8 data signal lines for each column of picture elements.

Under the conditions described above (e.g., either there are 3240 or more scan signal lines, and the diagonal dimension is 60 inches or larger, or the refresh rate is 120 Hz), double-sided source input drive is often still short of providing a sufficient charging rate in single source structures. A double source structure is hence required to increase the charging rate. Therefore, the present embodiment is suitably applicable to a liquid crystal display device that requires double-sided source input drive in a double source structure for sufficient charging rate. The present embodiment is also suitably applicable to a liquid crystal display device having the single source structure (details will be given later) shown in FIG. 9 if the liquid crystal display device is capable of double-sided source input drive. This type of liquid crystal display device is in some cases needed to accommodate recent demands for high quality design, by eliminating auxiliary wiring to narrow down the frame.

The display unit 2 is divided into a plurality of blocks (local areas), each measuring 1 pixel in the longitudinal direction and 12 pixels in the lateral direction. For example, as to an i-th row of pixels, a block Bi1 contains the pixels i1 to i12, and a block Bi2 contains the pixels i13 to i24; as to a j-th row of pixels, a block Bj1 contains the pixels j1 to j12, and a block Bj2 contains the pixels j13 to j24; and as to a k-th row of pixels, a block Bk1 contains the pixels k1 to k12, and a block Bk2 contains the pixels k13 to k24.

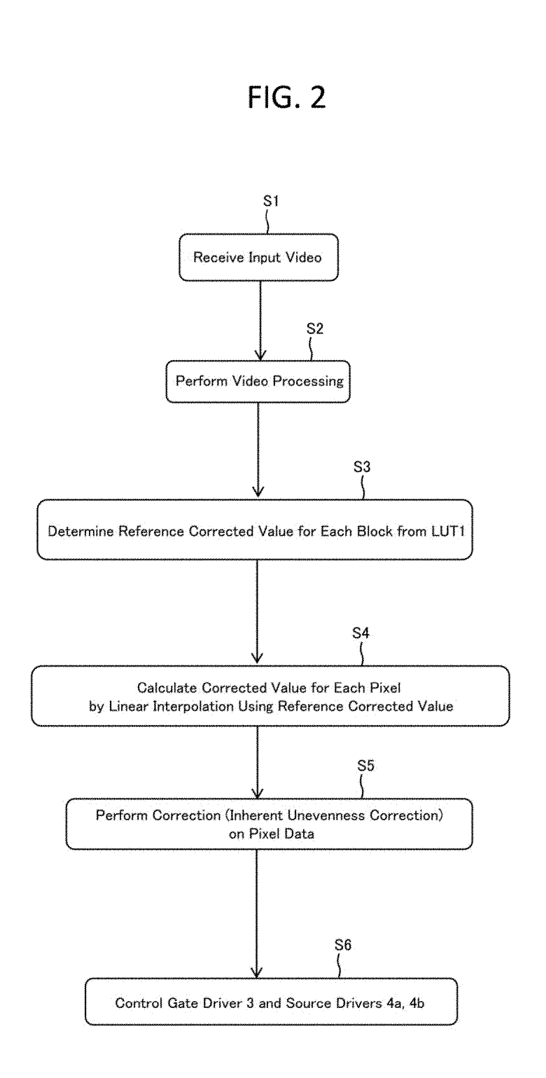

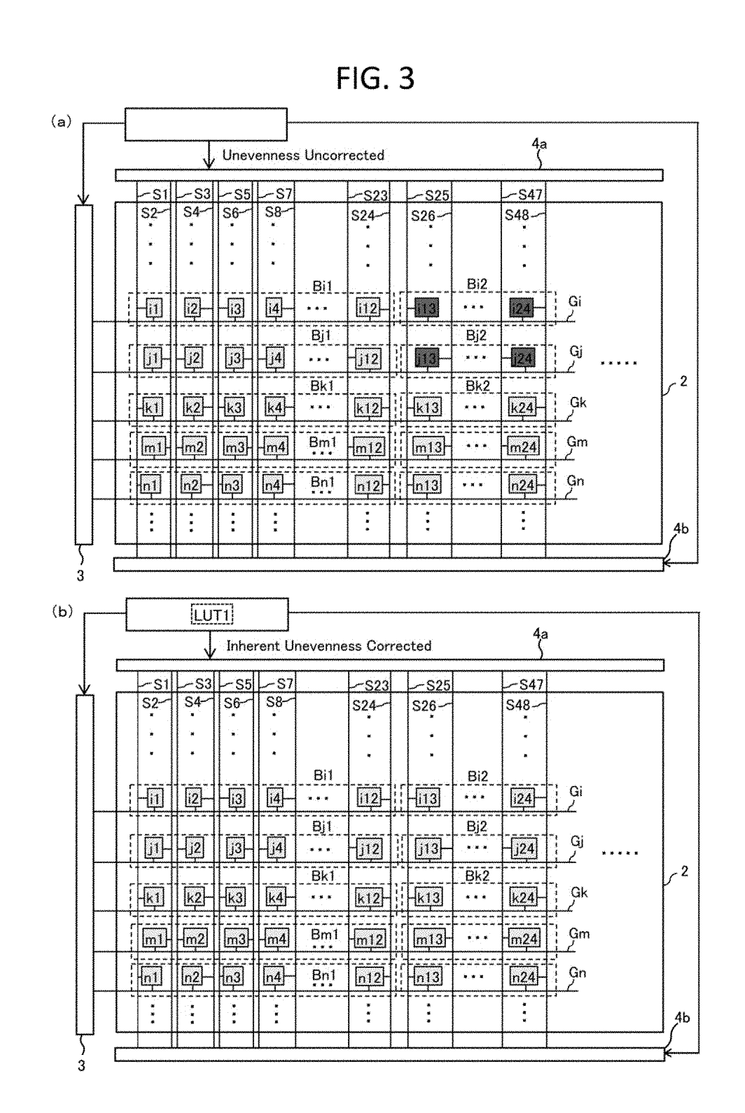

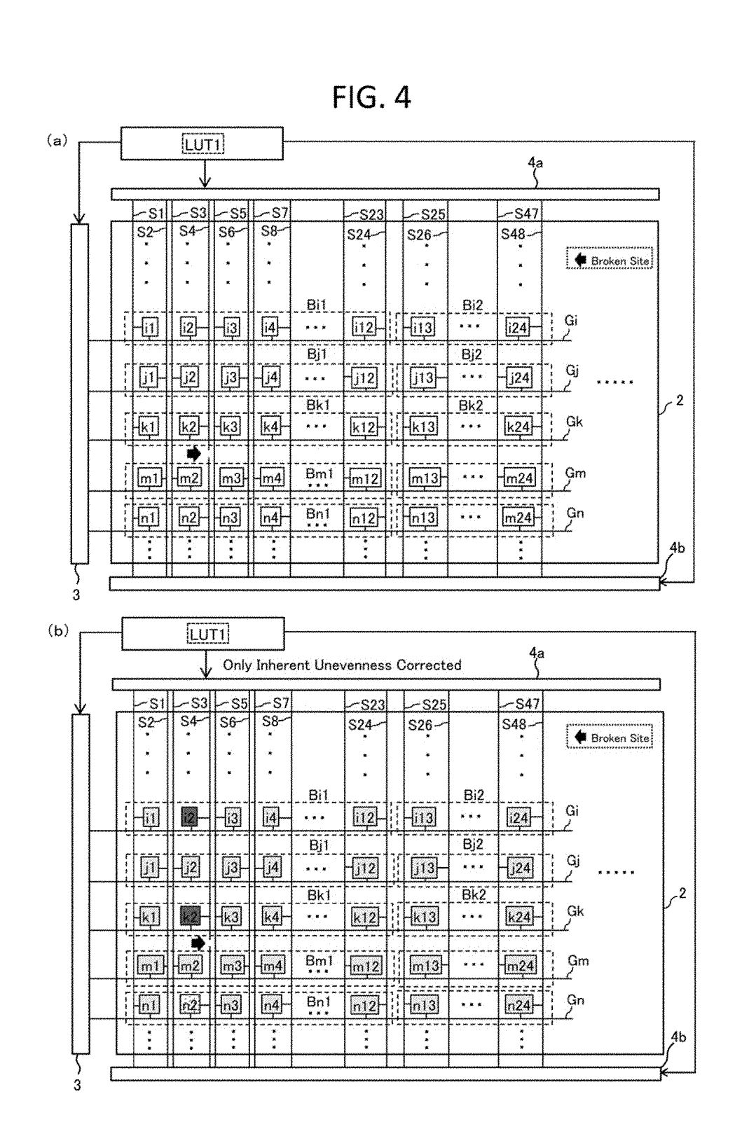

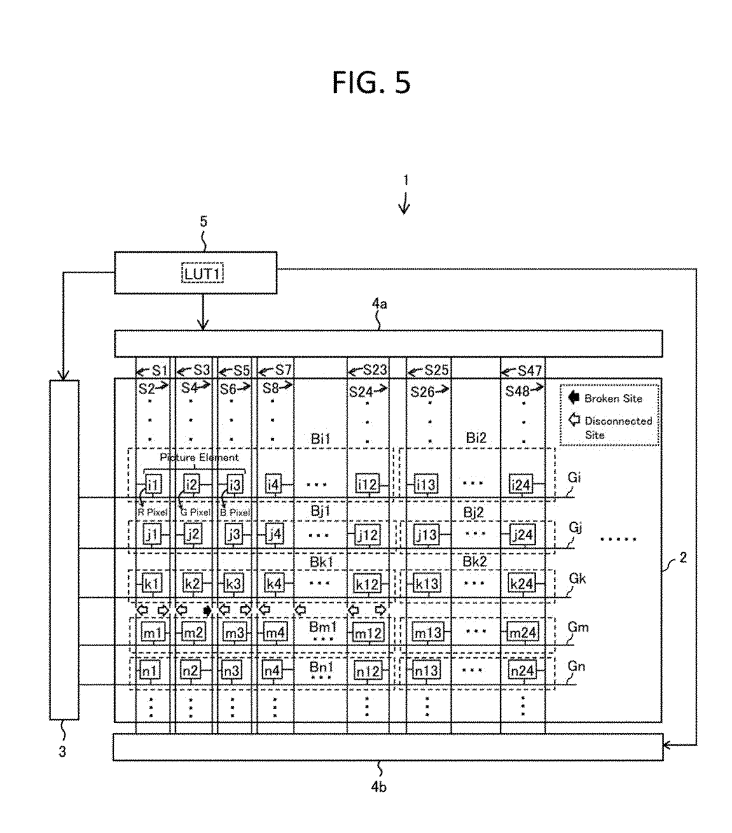

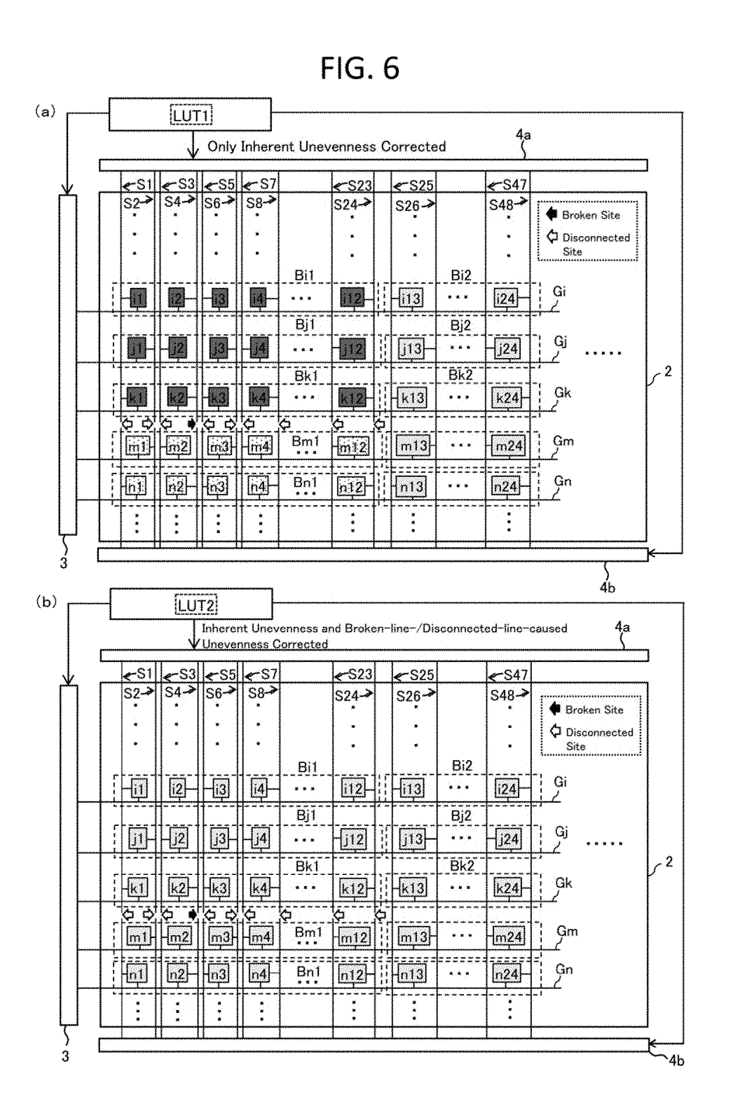

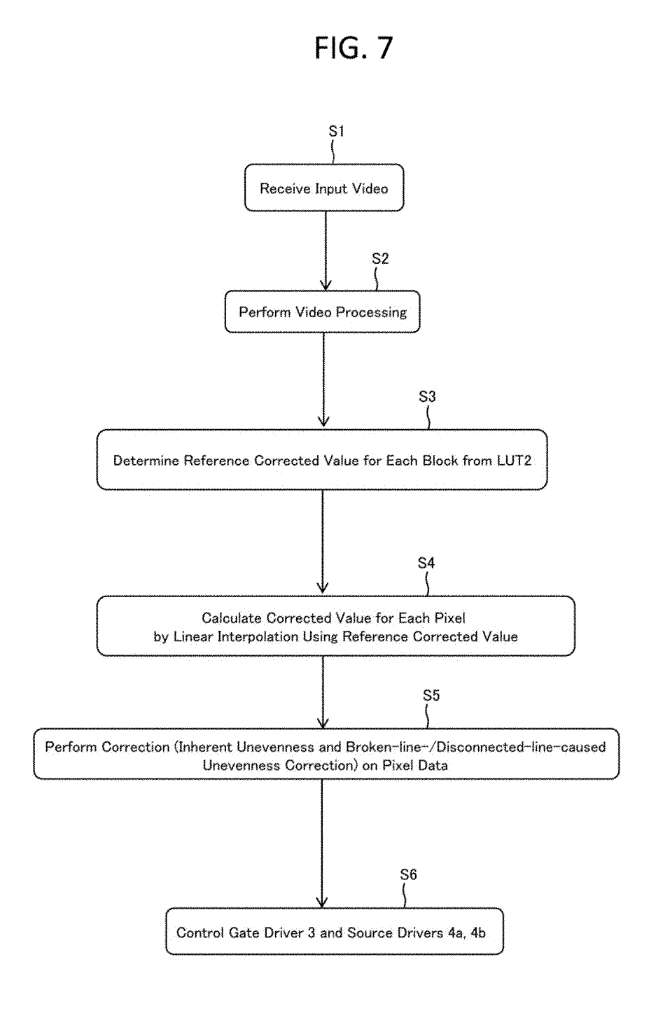

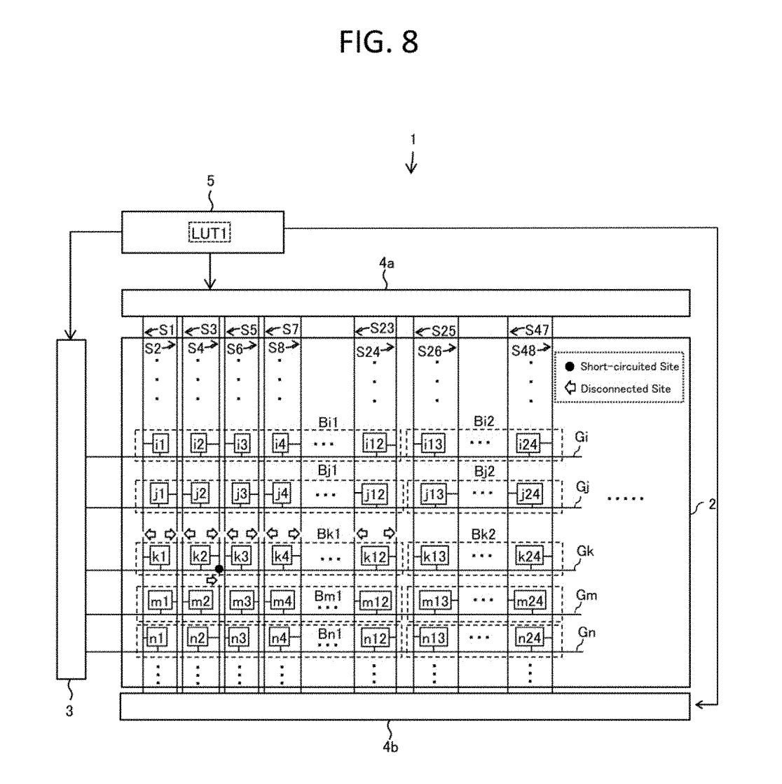

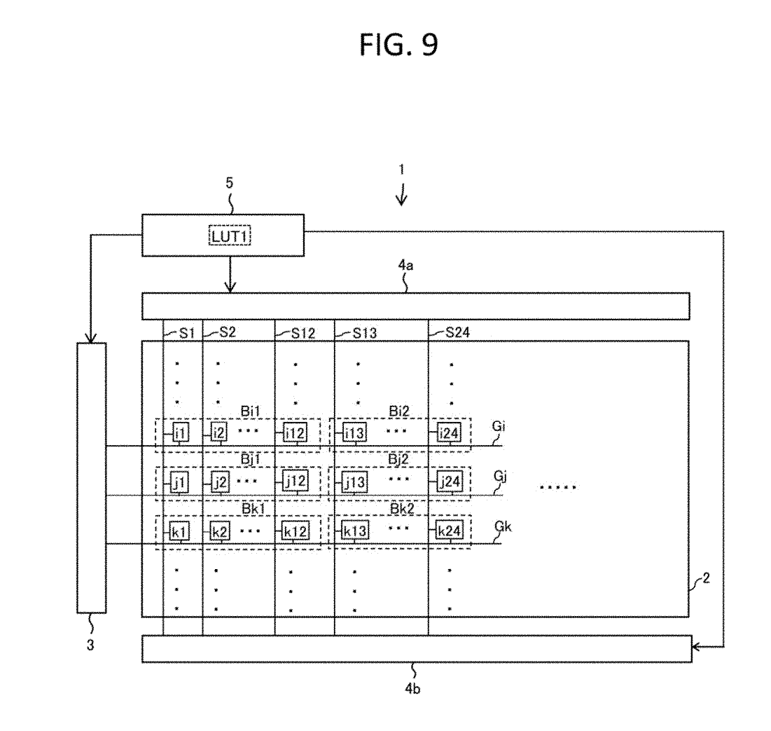

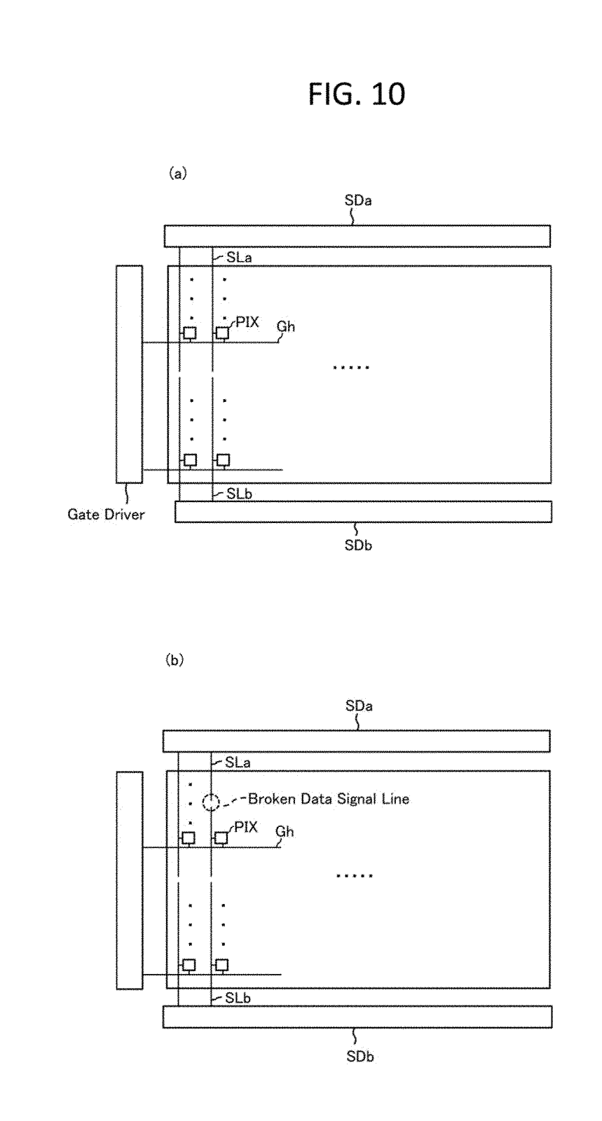

The control circuit 5 performs, for each block, input correction for pixels in that block. The input correction suppresses inherent unevenness caused by structural elements including the backlight, optical films, and liquid crystal panel. As an example, as depicted in FIG. 2, the control circuit 5 receives input video in step S1, performs predetermined video processing in step S2, thereafter obtains, from a lookup table LUT1, a plurality of corrected values each of which will be a reference for a different block (step S3), calculates a corrected value for each pixel by linear interpolation using the reference corrected values (step S4), and in step S5, performs such pixel data correction (input correction) that inherent unevenness can be suppressed. The control circuit 5 then controls the gate driver 3 and the source driver 4a using the corrected pixel data (step S6). Under the control of the control circuit 5, the gate driver 3 selects a scan signal line in a horizontal scan period, and the two source drivers 4a and 4b supply an identical data signal (signal potential corresponding to the corrected pixel data) to each data signal line in the same horizontal scan period.

Portion (a) of FIG. 3 is an example of a display produced if the input correction is not performed. It would be understood from that portion of the figure that dark unevenness (inherent unevenness) has occurred in the pixels i13 to i24 in the block Bi2 and the pixels j13 to j24 in the block Bj2 when a predetermined gray level is reproduced with no input correction. Performing the input correction depicted in FIG. 2 for the pixels i13 to i24 in the block Bi2 and the pixels j13 to j24 in the block Bj2 under these conditions suppresses the dark unevenness (inherent unevenness) throughout the blocks Bi2 and Bj2 as can be seen in (b) of FIG. 3.

The lookup table LUT1 contains a plurality of corrected values for unevenness correction throughout a single block. Each local area in the present embodiment is preferably set up to have a greater dimension in the lateral direction than in the longitudinal direction: for example, 1×12. When this is actually the case, if the lookup table LUT1 contains corrected values C1 and C12 for the pixels located on the ends of each block (the pixels i1 and i12), for example, a corrected value C8 for the eighth pixel can be calculated by simple linear interpolation between the two points and given by the formula: C8=C1+{(C12−C1)/(12−1)}×(8−1).

The local area may have a lateral dimension of, for example, 16 or 32 for more simple calculation. The corrected values for the 1st and 33rd pixels may be used in correcting pixel data for the 1st to 32nd pixels for more simple division. These modifications can be made without departing from the scope of the present embodiment.

It is possible to specify an independent corrected value for each pixel (i.e., for each primary color). It is however desirable to specify associated corrected values for pixels (e.g., R, G, and B pixels) in each picture element (e.g., specify the same corrected value for all the pixels in each picture element) for more simple calculation, as well as for compatibility with other video processing and grayscale procedures.

The dimensions of the local area may be specified in any manner in accordance with various conditions. The lateral dimension may be selected from approximately 4 to 64 pixels by considering the condition of unevenness (e.g., linearity of unevenness) across the panel and case of implementation. If the lateral dimension is too large, the correction of inherent unevenness is too much to be linearly approximated, and intermediate corrected values need to be introduced, which complicates the calculation. On the other hand, if the lateral dimension is too small, the table grows too large in total size. In either case, the correction circuit needs to bear a heavier workload.

The longitudinal dimension varies depending on how the panel is driven and in what environment the display device is viewed (viewing distance, resolution, and the like) and may tolerably be, for example, two or four lines. If the longitudinal dimension grows large, the interpolation becomes two-dimensional, which complicates calculation. Therefore, generally, the longitudinal dimension is preferably specified not to exceed the size that the viewer recognizes as a single line on a display. In the present embodiment, preferably, the longitudinal dimension is basically one line and may be two lines, for example, when a double source structure (two-line simultaneous selection drive) is used to treat two lines collectively as a single line.

The lookup table LUT1, in a preferred example, contains three sets of data for each 1×n local area (input gray levels, a corrected value for the pixel on the left end, and a corrected value for the pixel on the right end) so that an actual corrected value for each pixel can be calculated from the input gray level and location of the pixel by interpolation. For example, if the three sets of data are (0,0,0), (63,10,12), (127,8,10), (191,4,6), and (255,0,0), and gray level 95 is inputted for the center of the local area, the corrected value for the left end is calculated to be (10+8)/2=9, the corrected value for the right end is calculated to be (12+10)/2=11, the corrected value for the center is calculated to be (9+11)/2=10, and the corrected gray level is calculated to be 95+10=105, and all these results are outputted.

Lattice points that are related to grayscale are designated at every 8 or 16 gray levels out of the 256 gray levels for simple calculation. The inventors have confirmed that these lattice points work reasonably well in the interpolation.

### Embodiment 1

In the liquid crystal display device 1, an end of each data signal line is connected to the source driver 4a, and the other end thereof is connected to the source driver 4b. Therefore, if, for example, the data signal line S4 is broken as shown in (a) of FIG. 4, the data signal line S4 as a whole (above and below the broken site) can still be driven. However, in the presence of such a broken site on the data signal line S4, the upper part of the data signal line S4, which is longer than half the length of the other data signal lines, is connected to more loads than are the normal data signal lines (e.g., the data signal lines S3 and S5), and the lower part of the data signal line S4, which is shorter than half the length of the other data signal lines, is connected to fewer loads than are the normal data signal lines (e.g., the data signal lines S3 and S5). For this reason, even after the input correction depicted in FIG. 2 (inherent unevenness correction) is performed, a pixel connected to the upper part of the data signal line S4 may be darker than the normal pixels left and right thereto (e.g., the pixel k2 is darker than the normal pixels k1 and k3), and a pixel connected to the lower part of the data signal line S4 may be brighter than the normal pixels left and right thereto (e.g., the pixel n2 is brighter than the normal pixels n1 and n3), as can be seen in (b) of FIG. 4. This unevenness in a column of pixels caused by a broken site on the data signal line S4 (broken-line-caused unevenness) is non-continuous and isolated, hence highly obtrusive.

Accordingly, in the liquid crystal display device 1, if at least one of the data signal lines corresponding to the pixels in a block is broken, all the other data signal lines are deliberately disconnected. Specifically, as to the data signal lines S1 to 24 corresponding to the pixels in the blocks Bi1, Bj1, and Bk1, since the data signal line S4 is broken, all the other data signal lines S1 to S3 and S5 to S24 are deliberately disconnected using, for example, a laser. In this example, the locations of the disconnected sites on the data signal lines S1 to S3 and S5 to S24 in the longitudinal direction are aligned with the location of the broken site on the data signal line S4 in the longitudinal direction, the distances from the source driver 4a to the disconnected sites on the data signal lines S1 to S3 and S5 to S24 are rendered equal to the distance from the source driver 4a to the broken site on the data signal line S4 (the loads on the upper parts of the data signal lines S1 to S24 are all rendered equal), and the distances from the source driver 4b to the disconnected sites on the data signal lines S1 to S3 and S5 to S24 are rendered equal to the distance from the source driver 4b to the broken site on the data signal line S4 (the loads on the lower parts of the data signal lines S1 to S24 are all rendered equal). Hence, the liquid crystal display device 1 is configured as shown in FIG. 5 (including the broken data signal line S4 and the disconnected data signal lines S1 to S3 and S5 to 24).

Subjecting the liquid crystal display device shown in FIG. 5 to the input correction depicted in FIG. 2 (only inherent unevenness correction) suppresses both the inherent unevenness observed throughout the blocks Bi2 and Bj2 in (a) of FIG. 3 and the unevenness observed within the single blocks Bi1, Bk1, and Bn1 in (b) of FIG. 4. That leaves block-to-block unevenness (broken-line-/disconnected-line-caused unevenness) in (a) of FIG. 6 unaddressed. Broken-line-/disconnected-line-caused unevenness refers to the dark unevenness in the blocks Bi1, Bj1, and Bk1 and the bright unevenness in the blocks Bm1 and Bn1.

The control circuit 5 performs, for each block, input correction (inherent unevenness correction and broken-line-/disconnected-line-caused unevenness correction) for the pixels in that block. As an example, as depicted in FIG. 7, the control circuit 5 receives input video in step S1, performs predetermined video processing in step S2, thereafter obtains, from a lookup table LUT2, a plurality of corrected values each of which will be a reference for a different block (step S3). Each of these corrected values, which will serve as a reference, is determined based on the location of the block of interest and the location of the broken site. Next, the control circuit 5 calculates a corrected value for each pixel by linear interpolation using the reference corrected values (step S4), and in step S5, performs such pixel data correction (input correction) that inherent unevenness and broken-line-/disconnected-line-caused unevenness can be suppressed. The control circuit 5 then controls the gate driver 3 and the source driver 4a using the corrected pixel data (step S6). Under the control of the control circuit 5, the gate driver 3 selects a scan signal line in a horizontal scan period, and the two source drivers 4a and 4b supply an identical data signal (signal potential corresponding to the corrected pixel data) to each data signal line in the same horizontal scan period. This configuration suppresses inherent unevenness and broken-line-/disconnected-line-caused unevenness, thereby realizing a proper display as shown in (b) of FIG. 6.

As described so far, the liquid crystal display device 1 reliably exhibits a sufficient pixel charging rate with a large display unit and affords a solution to broken data signal line problems without compromising on display quality.

The inspection of a data signal line for a broken site and the disconnection of a broken data signal line with a laser may be performed in the following manner.

First, these processes can be performed on a bare active matrix substrate, in which the data signal lines are so easy to disconnect to accomplish state-of-the-art quality correction. A drawback is that because the active matrix substrate by itself is not capable of producing a display thereon, a broken site may be overlooked. Another drawback is that short-circuiting between a data signal line and a scan signal line (“SG leak”) cannot be discovered.

Next, liquid crystal is injected between the active matrix substrate and an opposite substrate and, the two substrates are combined, to obtain a liquid crystal panel. The processes can also be performed on this liquid crystal panel, in which a display can be produced so that problems can be reasonably easily located.

The liquid crystal panel may be combined with, for example, a polarizer, to obtain a liquid crystal display device. If the inspection and disconnection processes are performed on the liquid crystal display device, problems can be easily located, but the laser light needs to travel through the polarizer to disconnect data signal lines. This requirement results in poor precision and may damage the polarizer, which is undesirable.

It would be understood from the description above that the processes are preferably performed once on the bare active matrix substrate and again on the liquid crystal panel. In view of cost and other factors involved, however, it would be generally sufficient if the processes are performed primarily on the liquid crystal panel.

The LUT2 is preferably prepared on the basis of simultaneous evaluation of inherent unevenness and broken-line-/disconnected-line-caused unevenness in the liquid crystal display device.

Each block in Embodiment 1 measures 1 pixel in the longitudinal direction and 12 pixels in the lateral direction. Alternatively, the block may be of a smaller size (e.g., measuring 1 pixel in the longitudinal direction and 4 pixels in the longitudinal direction) and may be of a larger size (e.g., measuring 1 pixel in the longitudinal direction and 24 pixels in the longitudinal direction). Setting the longitudinal dimension to 1 pixel adds to the number of blocks. Under this setting, however, the correction values can be calculated by simple linear interpolation between the corrected values (reference corrected values) at the left and right ends, and this calculation is completed for each single line. These advantages work in favor of reduction in size of the control circuit 5.

The display unit 2 includes three-color-structure (R, G, and B) picture elements as an example and may alternatively include four-color-structure (R, G, B, and Y (yellow)) picture elements. In addition, the pixels are not necessarily arranged in a matrix and may alternatively be arranged as in a λ type.

### Embodiment 2

Embodiment 1 has described correction of a broken data signal line. The liquid crystal display device 1 also allows for correction of short-circuiting between a data signal line and a scan signal line (“SG leak”).

Specifically, in the liquid crystal display device 1, if at least one of the data signal lines corresponding to the pixels in a block is short-circuited to a scan signal line, the short-circuited section is separated out, and all the other data signal lines are deliberately disconnected. More specifically, as to the data signal lines S1 to 24 corresponding to the pixels in the blocks Bi1, Bj1, and Bk1, since the data signal line S4 is short-circuited to the scan signal line Gk as shown in FIG. 8, the short-circuited section is separated out from the data signal line S4, and all the other data signal lines S1 to S3 and S5 to S24 are deliberately disconnected using, for example, a laser. To separate out the short-circuited section, the data signal line S4 is disconnected at two sites across the short-circuited site, so that the locations of the disconnected sites on the data signal lines S1 to S3 and S5 to S24 in the longitudinal direction are aligned with the location of one of the two disconnected sites on the data signal line S4 in the longitudinal direction.

The data signal lines S1 to S3 and S5 to S24 may be disconnected either between the blocks Bj1 and Bk1 or between the blocks Bk1 and Bm1 and preferably near the center of the display unit (between the blocks Bj1 and Bk1) where possible as shown in FIG. 8. The data signal lines S1 to S3 and S5 to S24, if disconnected near the center, will have a small difference above and below the disconnected site (between the upper and lower parts of the data signal lines S1 to S3 and S5 to S24). That difference, albeit tiny, facilitates the correction. This advantage being minor, other factors are preferably considered in determining at which sites the data signal lines S1 to S3 and S5 to S24 should be disconnected: for example, ease of correction with a laser and a requirement that those lines which are driven simultaneously in a double source structure should not be separated out. The pixel k2, connected to the separated part of the data signal line S4, is subjected to blackening, for example, by connecting the drain of the transistor to an auxiliary capacitor wire.

Performing only the inherent unevenness correction depicted in FIG. 2 on the liquid crystal display device shown in FIG. 8 which has undergone the short-circuited data signal line correction described above (including the short-circuited data signal line S4 and the disconnected data signal lines S1 to 3 and S5 to 24) leaves block-to-block unevenness (disconnected-line-caused unevenness). Disconnected-line-caused unevenness refers to the dark unevenness in the blocks Bi1 and Bj1 and the bright unevenness in the blocks Bk1, Bm1, and Bn1.

Accordingly, performing input correction on the liquid crystal display device shown in FIG. 8 in a similar manner to FIG. 7 suppresses inherent unevenness and disconnected-line-caused unevenness, thereby realizing a proper display.

The present invention is directed to a liquid crystal display device including: a control circuit configured to perform input correction for a plurality of pixels in each one of local areas of a display unit, the input correction performed separately for each local area; a first driver electrically connected to an end of each one of data signal lines that correspond to the pixels; and a second driver electrically connected to another end of each data signal line, wherein the first and second drivers drive the data signal lines based on the input correction.

In another aspect of the liquid crystal display device in accordance with the present invention, the first and second drivers supply an identical data signal to the data signal lines at an identical timing.

In yet another aspect of the liquid crystal display device in accordance with the present invention, the data signal lines that correspond to those of the pixels which are in at least one of the local areas include: at least one broken data signal line having a broken site thereon; and at least one disconnected data signal line having a deliberately disconnected site thereon.

In still another aspect of the liquid crystal display device in accordance with the present invention, the broken site and the disconnected site are aligned in a longitudinal direction, where the longitudinal direction is a direction in which the data signal lines extend.

In yet still another aspect of the liquid crystal display device in accordance with the present invention, the input correction, for the at least one of the local areas, suppresses both unevenness that occurs inherently and unevenness that occurs in connection with the broken and disconnected sites.

In a further aspect of the liquid crystal display device in accordance with the present invention, the data signal lines that correspond to those of the pixels which are in at least one of the local areas include: at least one short-circuited data signal line having thereon a short-circuited site where this particular data signal line is short-circuited to a scan signal line and two deliberately disconnected sites that reside across the short-circuited site; and at least one disconnected data signal line having a deliberately disconnected site thereon.

In yet a further aspect of the liquid crystal display device in accordance with the present invention, one of the two disconnected sites on the short-circuited data signal line and the disconnected site on the disconnected data signal line are aligned in a longitudinal direction, where the longitudinal direction is a direction in which the data signal lines extend.

In still a further aspect of the liquid crystal display device in accordance with the present invention, the input correction, for the at least one of the local areas, is intended to suppress both unevenness that occurs inherently and unevenness that occurs in connection with the two disconnected sites on the short-circuited data signal line and the disconnected site on the disconnected data signal line.

In yet still a further aspect of the liquid crystal display device in accordance with the present invention, for those of the pixels which are in the at least one of the local areas, the input correction is performed based on where that one of the local areas is located in the display unit in terms of the longitudinal direction.

In an additional aspect of the liquid crystal display device in accordance with the present invention, each one of the local areas contains one pixel in a longitudinal direction and 2 to 24 pixels in a lateral direction, where the longitudinal direction is a direction in which the data signal lines extend.

In another aspect of the liquid crystal display device in accordance with the present invention, the control circuit determines from a lookup table corrected values for at least two non-adjacent ones of the pixels in each one of the local areas as corrected values that serve as a plurality of references and determines corrected values for other pixels in that one of the local areas through interpolation using the corrected values that serve as the references.

In a further aspect of the liquid crystal display device in accordance with the present invention, one of the pixels in a column of pixels that extends in a longitudinal direction is connected to one of the data signal lines via a transistor, and another one of the pixels in the column is connected to another one of the data signal lines via a transistor, where the longitudinal direction is a direction in which the data signal lines extend.

The present invention is also directed to a method of manufacturing a liquid crystal display device including: a control circuit configured to perform input correction for a plurality of pixels in each one of local areas of a display unit, the input correction performed separately for each local area; a first driver electrically connected to an end of each one of data signal lines that correspond to the pixels; and a second driver electrically connected to another end of each data signal line, wherein the first and second drivers drive the data signal lines based on the input correction, the method including, as to the data signal lines that correspond to those of the pixels which are in each one of the local areas: (A) if at least one of those data signal lines is broken, deliberately disconnecting all the other data signal lines; and (B) if at least one of those data signal lines develops a short-circuited section where that one of the data signal lines is short-circuited to a scan signal line, separating out the short-circuited section and deliberately disconnecting all the other data signal lines.

The present invention is not limited to the embodiments and examples above. Proper variations and combinations of the embodiments and examples in view of general technical knowledge are encompassed in the technical scope of the present invention.

### INDUSTRIAL APPLICABILITY

The liquid crystal display device in accordance with the present invention is suitably applicable to liquid crystal televisions, liquid crystal monitors, and television monitors.

### REFERENCE SIGNS LIST

1 Liquid Crystal Display Device
2 Display Unit
3 Gate Driver
4a First Source Driver (First Driver)
4b Second Source Driver (Second Driver)
5 Control Circuit
Bi1, Bi2 Block (Local Area)
Bj1, Bj2 Block (Local Area)
Bk1, Bk2 Block (Local Area)
Bm1, Bm2 Block (Local Area)
Bn1, Bn2 Block (Local Area)
i1 to i24 Pixel
j1 to j24 Pixel
k1 to k24 Pixel
S1 to S48 Data Signal Line
Gi, Gj, Gk, Gm, Gn Scan Signal Line
LUT1, LUT2 Lookup Table

1. A liquid crystal display device comprising:
a control circuit configured to perform input correction for a plurality of pixels in each one of local areas of a display unit, the input correction performed separately for each local area;
a first driver electrically connected to an end of each one of data signal lines that correspond to the pixels; and
a second driver electrically connected to another end of each data signal line,
wherein the first and second drivers drive the data signal lines based on the input correction.

2. The liquid crystal display device according to claim 1, wherein the first and second drivers supply an identical data signal to the data signal lines at an identical timing.

3. The liquid crystal display device according to claim 1, wherein the data signal lines that correspond to those of the pixels which are in at least one of the local areas comprise: at least one broken data signal line having a broken site thereon; and at least one disconnected data signal line having a deliberately disconnected site thereon.

4. The liquid crystal display device according to claim 3, wherein the broken site and the disconnected site are aligned in a longitudinal direction, where the longitudinal direction is a direction in which the data signal lines extend.

5. The liquid crystal display device according to claim 4, wherein the input correction, for the at least one of the local areas, suppresses both unevenness that occurs inherently and unevenness that occurs in connection with the broken and disconnected sites.

6. The liquid crystal display device according to claim 1, wherein the data signal lines that correspond to those of the pixels which are in at least one of the local areas comprise: at least one short-circuited data signal line having thereon a short-circuited site where this particular data signal line is short-circuited to a scan signal line and two deliberately disconnected sites that reside across the short-circuited site; and at least one disconnected data signal line having a deliberately disconnected site thereon.

7. The liquid crystal display device according to claim 6, wherein one of the two disconnected sites on the short-circuited data signal line and the disconnected site on the disconnected data signal line are aligned in a longitudinal direction, where the longitudinal direction is a direction in which the data signal lines extend.

8. The liquid crystal display device according to claim 7, wherein the input correction, for the at least one of the local areas, suppresses both unevenness that occurs inherently and unevenness that occurs in connection with the two disconnected sites on the short-circuited data signal line and the disconnected site on the disconnected data signal line.

9. The liquid crystal display device according to claim 5, wherein for those of the pixels which are in the at least one of the local areas, the input correction is performed based on where that one of the local areas is located in the display unit in terms of the longitudinal direction.

10. The liquid crystal display device according to claim 1, wherein each one of the local areas contains one pixel in a longitudinal direction and 2 to 24 pixels in a lateral direction, where the longitudinal direction is a direction in which the data signal lines extend and the lateral direction is a direction perpendicular to the longitudinal direction.

11. The liquid crystal display device according to claim 1, wherein the control circuit determines from a lookup table corrected values for at least two non-adjacent ones of the pixels in each one of the local areas as corrected values that serve as a plurality of references and determines corrected values for other pixels in that one of the local areas through interpolation using the corrected values that serve as the references.

12. The liquid crystal display device according to claim 1, wherein one of the pixels in a column of pixels that extends in a longitudinal direction is connected to one of the data signal lines via a transistor, and another one of the pixels in the column is connected to another one of the data signal lines via a transistor, where the longitudinal direction is a direction in which the data signal lines extend.

13. A method of manufacturing a liquid crystal display device comprising: a control circuit configured to perform input correction for a plurality of pixels in each one of local areas of a display unit, the input correction performed separately for each local area; a first driver electrically connected to an end of each one of data signal lines that correspond to the pixels; and a second driver electrically connected to another end of each data signal line, wherein the first and second drivers drive the data signal lines based on the input correction,
the method comprising, as to the data signal lines that correspond to those of the pixels which are in each one of the local areas:
(A) if at least one of those data signal lines is broken, deliberately disconnecting all the other data signal lines; and
(B) if at least one of those data signal lines develops short-circuiting where that one of the data signal lines is short-circuited to a scan signal line, separating out a short-circuited site and deliberately disconnecting all the other data signal lines.

14. The liquid crystal display device according to claim 8, wherein for those of the pixels which are in the at least one of the local areas, the input correction is performed based on where that one of the local areas is located in the display unit in terms of the longitudinal direction.
